(19) United States
(12) Patent Application Publication
(10) Pub. No.: US 2007/0104560 A1
(43) Pub. Date: May 10, 2007

(54) Log Transport Device

(76) Inventor: Robert Hall, Kaministiquia (CA)

Correspondence Address: ADE & COMPANY INC., 2157 Henderson Highway, WINNIPEG, MB, R2G1P9, CA

(21) Appl. No.: 11/552,271

(22) Filed: Oct. 24, 2006

Related U.S. Application Data
(60) Provisional application No. 60/734,779, filed on Nov. 9, 2005.

(51) Int. Cl. B65F 3/26

(52) U.S. Cl. 414/494

(57) ABSTRACT

A log transport device comprises an elongate base frame supported on wheels. A boom is pivotally supported on the base frame and supports a boom pulley supported thereon spaced from a pivot axis of the boom for pivotal movement with the boom relative to the base frame from a rear position in which the boom pulley is spaced above the rear end of the base frame, through an intermediate position in which the boom pulley is spaced upwardly and forwardly in relation to the rear position, to a forward position in which the boom pulley is spaced forwardly in relation to the intermediate position. A winch cable, coupled to a winch at a first end of the frame, extends over the boom pulley for connection to a load at the free end of the cable to permit lifting and pulling of a log forwardly onto the frame of the transport device without any costly hydraulically powered equipment or hydraulic pumps and the like being required.

This application claims the benefit under 35 U.S.C.119(e) of U.S. provisional application Ser. No. 60/734,779, filed Nov. 9, 2005.

### FIELD OF THE INVENTION

The present invention relates to a device for transporting logs in which the device includes a base frame supported for rolling movement along the ground and a mechanism for loading a load to be transported, for example logs, onto the base frame.

### BACKGROUND

In the logging industry it is common to use trucks and transport trailers for transporting logs between various sites. A typical trailer includes a flat deck with side walls for containing the load on the deck. Loading is typically accomplished by a hydraulically powered knuckle boom and swivel grapple for grappling the logs and then subsequently lifting and orienting the logs onto the deck of the trailer. Such hydraulically powered equipment is typically costly and requires additional costly maintenance due to the various working components of the pump and hydraulic actuators.

### SUMMARY OF THE INVENTION

According to one aspect of the invention there is provided a log transport device comprising:

a base frame arranged for supporting a load thereon, the base frame extending in a longitudinal direction from a front end to a rear end of the base frame;

wheels supporting the base frame for rolling movement along the ground in the longitudinal direction;

a winch supported at the front end of the base frame;

a boom pivotally supported on the base frame for pivotal movement relative to the base frame about a respective boom axis:

a boom pulley supported on the boom spaced from the boom axis and arranged for pivotal movement with the boom relative to the base frame from a rear position in which the boom pulley is spaced above the rear end of the base frame, through an intermediate position in which the boom pulley is spaced upwardly and forwardly in relation to the rear position, to a forward position in which the boom pulley is spaced forwardly in relation to the intermediate position; and

a winch cable coupled to the winch at a first end of the winch cable and arranged to extend over the boom pulley to a second end of the winch cable, the second end of the winch cable being arranged for connection to a load to be supported on the base frame.

The combination of a boom pulley supported on a pivotal boom with a winch permits lifting and pulling of a log forwardly onto the frame of the transport device without any costly hydraulically powered equipment or hydraulic pumps and the like.

Preferably a damping system is provided for damping pivotal movement of the boom in relation to the base frame. The damping system may comprise a hydraulic member supported for linear sliding movement between the base frame and the boom and which is connected in series with a flow restrictor.

There may be provided a reset pulley supported on the base frame adjacent the rear end thereof for receiving the winch cable thereabout when pulling the boom rearward.

Preferably a locking mechanism is provided for selectively locking the boom in the rear position for unloading logs. The locking mechanism may be adjustable for adjusting inclination of the boom in the rear position.

Preferably the boom axis is spaced rearwardly of the wheels, towards the rear end of the base frame. Also, the boom axis is preferably oriented generally horizontally and generally perpendicular to the longitudinal direction.

The boom may comprise a pair of pivot arms with each pivot arm being pivotally supported at an inner end at a respective side of the base frame. A cross member preferably connects the pivot arms at respective outer ends thereof for pivotal movement of the pivot arms together about the boom axis and for supporting the boom pulley thereon. Location of the boom axis may be adjustable in the longitudinal direction.

Preferably the boom pulley is supported at an outer free end of the boom, laterally centered on the boom with respect to the base frame. Spacing of the boom pulley relative to the boom axis may be adjustable.

The winch is preferably electrically driven and is preferably mounted spaced above the base frame sufficiently that the winch cable extends overtop of the load supported thereon. There may be provided a plurality of rollers receiving the winch cable therebetween for guiding the winch cable to extend rearwardly from the winch.

The base frame may be generally U-shaped in cross section to define a cradle for receiving the load therein.

When the base frame comprises a trailer frame, a hitch connector is preferably supported at the front end thereof. Alternatively, the boom may be supported on a truck box, in which the truck box defines the base frame which supports the load thereon.

Some embodiments of the invention will now be described in conjunction with the accompanying drawings in which:

### BRIEF DESCRIPTION OF THE DRAWINGS

FIG. 1 is a perspective view of a first embodiment of the log transport device.

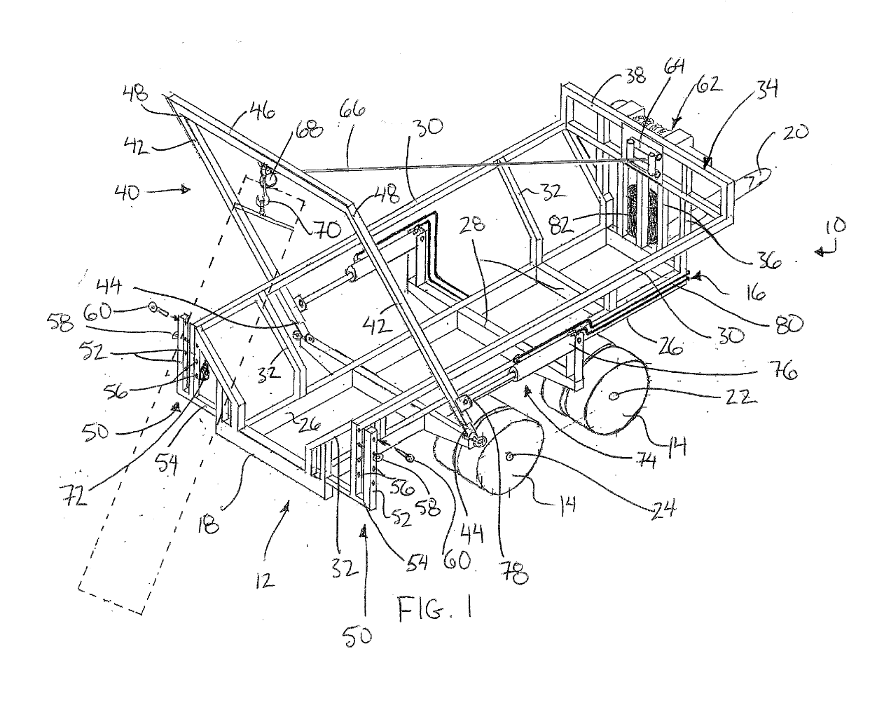

FIG. 2 is a side elevational view of a second embodiment of the log transport device illustrating a log in solid line before unloading and in broken line after unloading.

FIG. 3 is a side elevational view of the device according to FIG. 2 illustrating a log in solid line prior to loading onto the device and in broken line supported on the device.

FIG. 4 is a rear elevational view of the device according to FIGS. 2 and 3.

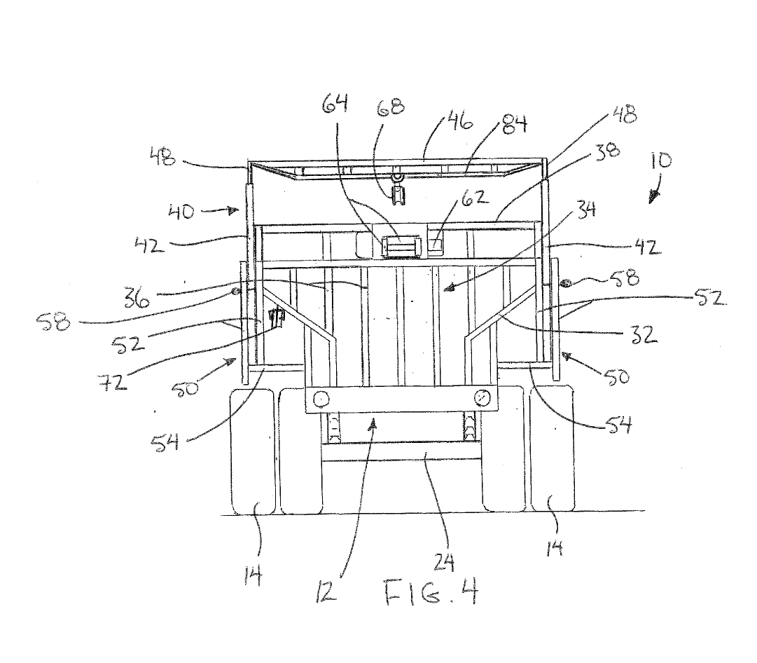

FIGS. 5A through 5E illustrate the various steps during the loading operation of a log onto the transport device.

FIGS. 6A through 6D illustrate the various steps of a log being unloaded from the device.

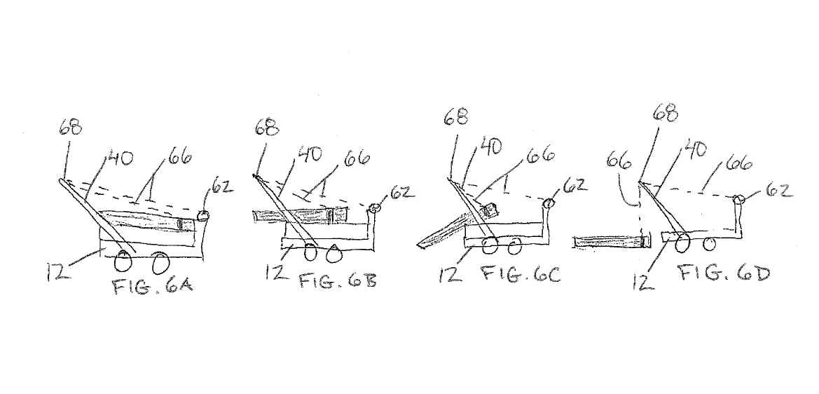

In the drawings like characters of reference indicate corresponding parts in the different figures.

### DETAILED DESCRIPTION

Referring to the accompanying figures there is illustrated a log transport device generally indicated by reference numeral 10. The device 10 is particularly suited for transporting logs or lumber or other large objects requiring some powered assistance to place the object or load onto the transport device for transport. Though two embodiments are shown in the accompanying figures, the common features will first be described herein.

The device 10 includes a base frame 12 supported on wheels 14 for rolling movement on the ground in a longitudinal direction extending from a front end 16 to a rear end 18 of the base frame. A hitch connection 20 is provided at the front end 16 of the frame for attachment to a suitable towing vehicle. The wheels 14 are supported at opposing ends of both a central axle 22 positioned slightly forwardly of a longitudinal center of the base frame and a rear axle 24 spaced rearwardly of the central axle towards the rear end of the frame. Single or double wheels can be supported at each end of each axle.

The base frame 12 includes two base rails 26 oriented parallel to one another spaced apart and extending in the longitudinal direction from the front end to the rear end of the frame. A plurality of cross members 28 extend perpendicularly to the rails for being connected between the rails to define a deck surface upon which logs and the like can be supported.

The base frame further includes two side rails 30 extending in the longitudinal direction which are also parallel to one another and spaced apart. The side rails are spaced apart from one another wider than the base rails and are spaced above the base rails. Each side rail 30 is spaced upwardly and laterally outwardly from the respective base rail 26 for locating the wheels 14 below the side rails.

A plurality of side bars 32 extend at a generally upward and outward incline from the base rails 26 to the side rails 30 along each side of the base frame to provide further support to logs which are stacked on the deck of the base frame. The cross members 28 between the base rails and the side bars 32 extending from the base rails to the side rails respectively thus define a generally U-shaped cradle for containing logs therein. The cradle shape of the base frame is open at the rear end for loading and unloading therethrough. A front wall 34 is provided at the front end of the base frame which comprises a plurality of vertical posts 36 spaced laterally from one another and joined together by a header 38 spanning across the top ends thereof. The header 38 comprises a pair of vertically spaced and horizontally extending rigid bars.

A boom structure 40 is pivotally mounted on the base frame 12 for relative pivotal movement therebetween. The boom structure 40 comprises two pivot arms 42 which are each pivotally mounted at the respective inner ends 44 thereof on the base frame for pivotal movement about a common boom axis which is oriented perpendicularly to the longitudinal direction of the base frame and extends horizontally in a lateral direction.

The pivot arms 42 are joined at a top outer end by a cross member 46 so that the free ends 48 of the pivot arms are moveable together with the cross member 46 as the pivot arms of the boom structure are pivoted relative to the base frame. The boom axis is located at the height of the base rails with the pivot mounts which pivotally mount the inner ends of the pivot arms 42 respectively thereon being spaced laterally outwardly wider than the side rails thereabove. The pivot mounts of the pivot arms 42 are also spaced rearwardly of the rear axle towards the rear end of the frame while being spaced slightly forwardly from the rear end itself.

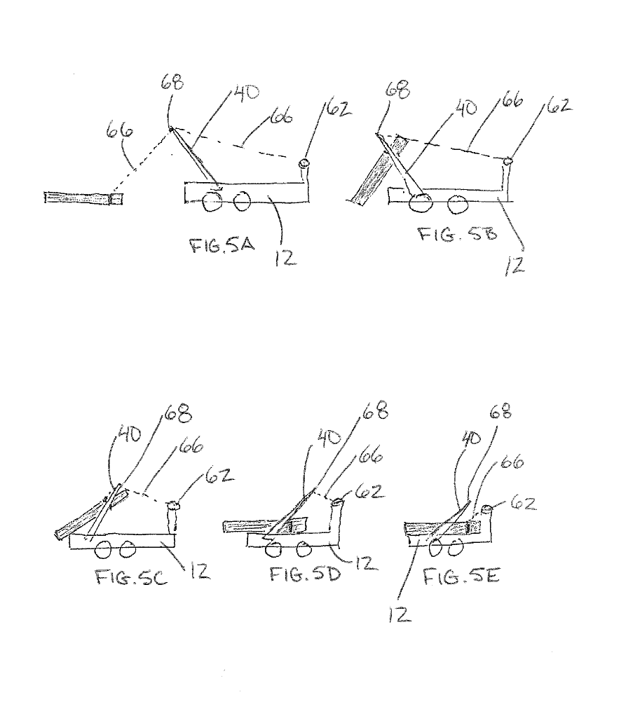

Each of the pivot arms 42 is arranged for pivoting movement within a respective vertical sweep plane oriented in the longitudinal direction. The cross member 46 thus remains horizontal and perpendicular to the longitudinal direction as the pivot arms are pivoted relative to the base frame. The cross member thus follows an arc motion with pivoting of the boom structure from a rear position shown in FIG. 5A in which the pivot arms extend upwardly and rearwardly to the cross member 46 which is spaced upwardly and rearwardly from the rear end of the base frame, through an intermediate position as shown in FIG. 5C in which the pivot arms extend generally upwardly to the cross member which is positioned forwardly and upwardly in relation to the rear position, to a forward position as shown in FIG. 5D in which the pivot arms 42 extend upwardly and forwardly to the cross member which is positioned forwardly and downwardly in relation to the intermediate position.

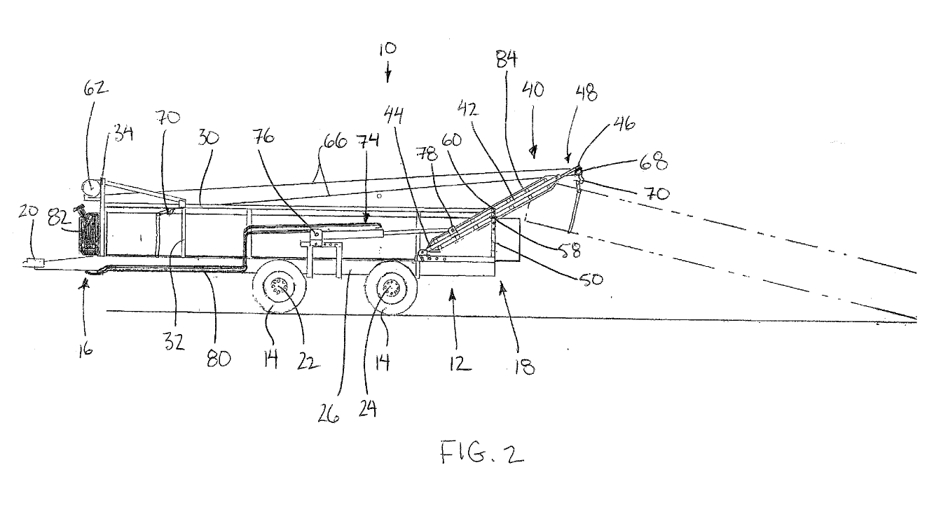

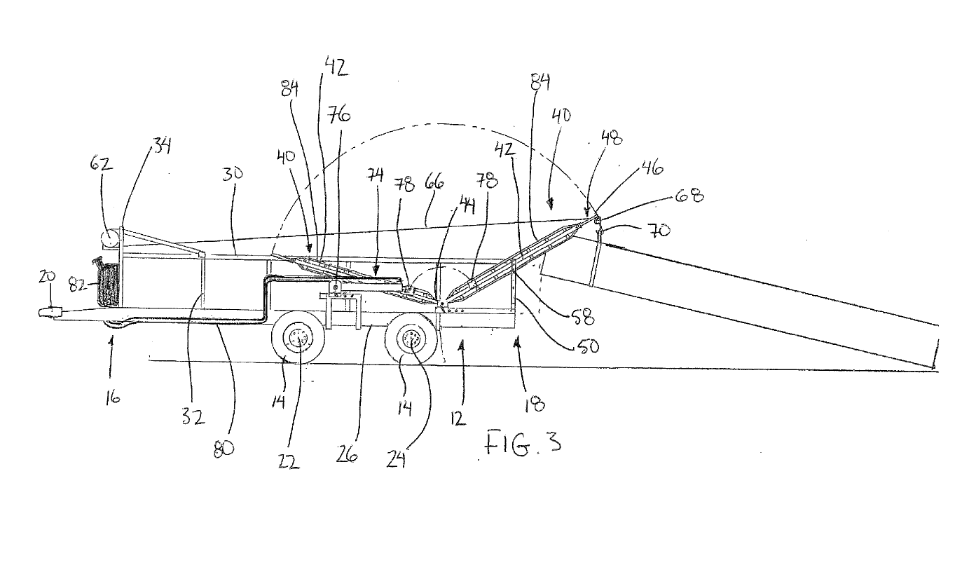

Two boom supports 50 are provided at the rear end of the frame spaced apart from one another on opposing sides of the base frame. The boom supports support the boom structure 40 in the rear position as shown in FIGS. 2 and 3. Each boom support comprises a pair of vertically extending posts 52 which are laterally spaced apart from one another and which are parallel with one another to define a vertical slot therebetween which slidably receives a respective one of the pivot arms 42 therein.

The posts 52 of the boom supports extend between a bottom end at the height of the base rails to top end at the height of the side rails with the boom supports 50 being spaced apart from one another approximately the spacing of the pivot arms 42 from one another. In this manner each boom support 50 aligns with the respective one of the pivot arms 42. The posts 52 are supported by a cross bar 54 which encloses a bottom end of the slot defined between the posts and connects the posts to the base rails of the base frame.

Cooperating apertures 56 are provided at vertically spaced positions along the vertical posts 52 for selectively receiving locking pins 58 therein. The height of the locking pins 58 can thus be adjusted so that the height of the boom structure in the rear position can be adjusted as the pivot arms 42 rest on the locking pins 58 in the rear position. A second locking pin 60 may be provided for securement above the first locking pin 58 with the respective one of the pivot arms 42 received therebetween for locking the boom structure in the rear position as desired.

A winch 62 is provided at the front end of the base frame spaced above the base rails and the side rails. The winch 62 includes a 12 volt electric motor for driving rotation of the winch. The winch is supported on the header at the top end of the front wall 34 of the base frame. Rollers 64 are provided immediately rearward of the winch 62 in the form of a vertically spaced pair and a horizontally spaced pair of rollers for guiding a winch cable 66 through the rollers when the winch cable 66 extends rearwardly of the winch 62. The winch cable 66 is coupled at a first end to a winding drum of the winch for winding the winch cable 66 onto the winch when driven by the motor.

A boom pulley 68 is mounted at the free end of the boom structure 40 so as to be centered laterally on the cross member 46 extending between the pivot arms of the boom structure. The winch cable 66 is extended over and around the boom pulley 68 for various operations during loading and unloading of logs onto the base frame. The boom pulley 68 is supported for rotation about a horizontal axis oriented perpendicularly to the longitudinal direction.

When loading a log onto the base frame, the boom structure is first positioned in the rear position and the winch cable is extended over the boom pulley 68 for attachment at a second free end of the winch cable to a hook 70 which grips the log to be loaded. The second locking pins 60 of the boom supports are removed to permit pivotal movement of the boom structure, Winding the winch cable onto the winch causes the hook 70 and the log carried thereon to be drawn upwardly and forwardly towards to boom pulley 68 at the free end of the boom structure. As the hook approaches the boom pulley continued winding of the winch begins to pull the boom structure forwardly through the intermediate position which causes the log to be both lifted and pulled forwardly. Continued winding of the winch results in the boom being positioned in the forward position sloped upwardly and forwardly with a majority of the log being supported on the base frame. The winch cable 66 can then be released from the boom pulley 68 for subsequent direct connection between the hook 70 carrying the log and the winch 62 so that continued winding of the winch draws the log for abutment against the front end of the base frame.

For a subsequent unloading operation, the boom must be displaced back to the rear position. A reset pulley 72 is supported at the rear end of the frame adjacent one of the boom supports 50 so as to be spaced laterally outwardly in relation to the base rails, and below the respective side rails. The winch cable 66 can thus be extended from the winch about the reset pulley 72 and back to the boom structure positioned in the forward position. Winding of the winch thus causes the winch cable to pull the boom structure towards the reset pulley 72 to return the boom structure to the rear position. Once in the rear position, the second locking pins 60 are inserted for locking the boom structure in the rear position. The winch cable 66 is then removed from the reset pulley and is instead extended from the winch over and around the boom pulley 68 for connection of the hook at the second end to the front end of the log adjacent the front end of the base frame. Winding of the winch in this instance pulls the hook rearwardly towards to boom pulley 68 which is maintained upwardly and rearwardly in relation to the rear end of the frame in the rear position. Once the front end of the log has been displaced rearward of the rear end of the frame, the log has been successfully unloaded. The unloading operation can be performed for unloading logs directly onto the ground or onto another deck or platform having a height which is near or below the height of the base rails of the frame.

A damping system is provided for connection to boom structure to dampen the pivoting movement of the boom structure from the rear position to the forward position. The damping system generally comprises a hydraulic piston cylinder 74 which is coupled to each of the pivot arms of the boom structure.

Each of the piston cylinders 74 is pivotally mounted at a cylinder end 76 on the base frame at a position spaced forwardly and upwardly in relation to the pivot mount of the respective pivot arm 42 but is spaced below the respective side rail. The rod end 78 of the piston cylinder is pivotally mounted on the respective pivot arm 42 at a location spaced from the boom axis by a height corresponding to the height of the cylinder end 76 being pivotally mounted above the base rails. In this manner the hydraulic piston cylinder 74 on each side of the boom structure is oriented generally horizontally when the boom extends generally upwardly.

The piston cylinders 74 are arranged to be extended and retracted as the boom pivots between its respective positions. Hydraulic fluid lines 80 are coupled to opposing ends of the cylinders of the hydraulic piston cylinders in a closed circuit configuration in series with a fluid reservoir 82 and flow restrictors in line with the hydraulic fluid line 80 to partially restrict the fluid flow to limit the rate at which the boom structure can be pivoted. No pumping equipment is required for pressurizing the fluid lines 80 in any way as the hydraulic piston cylinders 74 act only as dampers and do not provide any powered assistance to pivoting movement of the boom structures.

Turning now more specifically to the embodiments of FIGS. 2 and 3, the pivot arms 42 and the cross member 46 of the boom structure are reinforced by suitable bracing 84 forming a truss structure. Each of the pivot arms 42 is also arranged to be telescopic for adjusting the spacing of the cross member 46 extending therebetween relative to the boom axis about which the boom structure is pivoted. By lengthening the pivot arms, the overall height of the boom pulley supported on the cross member can be increased for increasing the amount of lifting accomplished during loading. Location of the pivot axis can also be adjusted in the longitudinal direction by providing a plurality of pivot mount locations for pivotally supporting the pivot arms 42 on the base frame. A plurality of mounting locations are also provided for the cylinder end 76 of the hydraulic piston cylinders in which the plural mounting locations are spaced apart in the longitudinal direction corresponding to the various pivot mount locations for the boom structure so that the hydraulic piston cylinders 74 can be maintained in an ideal operating range.

The hydraulic damping system described herein is unique in that there is no motor, pump or any other controls required for operation of the hydraulics other than the two hydraulic pistons cylinders 74, the fluid lines 80 and the fluid reservoir 82. The simplicity of the design allows the electrically driven winch to perform all of the work of the pivoting movement of the boom structure which in turn lifts and displaces the logs forwardly onto the base frame during loading. The winch is arranged to overpower the hydraulic damper in a controlled manner for lifting and displacing logs forwardly onto the base frame in a controlled manner.

The hitch connection of the trailer can be arranged for connection to a conventional bumper hitch or to a fifth wheel hitch while remaining lightweight and flexible for all terrains and environmentally sensitive areas. In an alternative embodiment, the components of the log transport device may be provided as a kit for mounting on a conventional pickup truck box in which the truck box itself comprises the base frame supported for rolling movement along the ground to which the boom structure is pivotally mounted for relative pivotal movement.

The boom structure can also be adjusted to accommodate various size loads and logs The simplicity of the winch driven loading and unloading operations allows for these operations to be easily completed by a single operator. The transport device is not limited to logs however as any load which requires to be lifted upwardly and forwardly onto a base frame could be lifted using the winch and boom structure of the present invention.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A log transport device comprising:
a base frame arranged for supporting a load thereon, the base frame extending in a longitudinal direction from a front end to a rear end of the base frame;
wheels supporting the base frame for rolling movement along the ground in the longitudinal direction;
a winch supported at the front end of the base frame;
a boom pivotally supported on the base frame for pivotal movement relative to the base frame about a respective boom axis;
a boom pulley supported on the boom spaced from the boom axis and arranged for pivotal movement with the boom relative to the base frame from a rear position in which the boom pulley is spaced above the rear end of the base frame, through an intermediate position in which the boom pulley is spaced upwardly and forwardly in relation to the rear positions to a forward position in which the boom pulley is spaced forwardly in relation to the intermediate position; and
a winch cable coupled to the winch at a first end of the winch cable and arranged to extend over the boom pulley to a second end of the winch cable, the second end of the winch cable being arranged for connection to a load to be supported on the base frame.

2. The device according to claim 1 wherein there is provided a damping system for damping pivotal movement of the boom in relation to the base frame.

3. The device according to claim 2 wherein the damping system comprises a hydraulic member supported for linear sliding movement between the base frame and the boom.

4. The device according to claim 2 wherein the damping system comprises a hydraulic member connected in series with a flow restrictor.

5. The device according to claim 1 wherein there is provided a reset pulley supported on the base frame adjacent the rear end thereof for receiving the winch cable thereabout when pulling the boom rearward.

6. The device according to claim 1 wherein there is provided a locking mechanism for locking the boom in the rear position.

7. The device according to claim 6 wherein the locking mechanism is adjustable for adjusting inclination of the boom in the rear position.

8. The device according to claim 1 wherein the boom axis is spaced rearwardly of the wheels, towards the rear end of the base frame.

9. The device according to claim 1 wherein the boom axis is oriented generally horizontally and generally perpendicular to the longitudinal direction.

10. The device according to claim 1 wherein the boom comprises a pair of pivot arms, each pivot arm being pivotally supported at an inner end at a respective side of the base frame, and a cross member connecting the pivot arms at respective outer ends thereof for pivotal movement of the pivot arms together about the boom axis.

11. The device according to claim 1 wherein spacing of the boom pulley relative to the boom axis is adjustable.

12. The device according to claim 1 wherein the boom pulley is supported at an outer free end of the boom.

13. The device according to claim 1 wherein the boom pulley is laterally centered on the boom.

14. The device according to claim 1 wherein location of the boom axis is adjustable in the longitudinal direction.

15. The device according to claim 1 wherein the winch is spaced above the base frame.

16. The device according to claim 1 wherein the winch is electrically driven.

17. The device according to claim 1 wherein there is provided a plurality of rollers receiving the winch cable therebetween for guiding the winch cable to extend rearwardly from the winch.

18. The device according to claim 1 wherein the base frame is generally U-shaped in cross section to define a cradle for receiving the load therein.

19. The device according to claim 1 wherein the base frame comprises a trailer frame including a hitch connector supported at the front end thereof.

20. The device according to claim 1 in combination with a truck wherein the base frame comprises the truck box of the truck.
